(19) United States
(12) Patent Application Publication
(10) Pub. No.: US 2015/0365905 A1
(43) Pub. Date: Dec. 17, 2015

(54) TRANSMISSION POWER REGULATION

(71) Applicant: HANGZHOU H3C TECHNOLOGIES CO.LTD., Hangzhou City (CN)

(72) Inventor: Feng XUE, Beijing (CN)

(21) Appl. No.: 14/764,480

(22) PCT Filed: Jan. 29, 2014
(86) PCT No.: PCT/CN2014/071743

§ 371 Date: Jul. 29, 2015

(30) Foreign Application Priority Data
Feb. 5, 2013 (CN) 201310045956.9

(51) Int. Cl. H04W 52/24; H04W 52/14; H04W 52/36

(52) U.S. Cl. CPC H04W 52/241; H04W 52/362; H04W 52/143

(57) ABSTRACT

Transmission power regulation of a wireless access point (104) is described. In a method, a first indication of signal quality of a signal received by the access point (104) from a terminal (106) is acquired. An indication of a communication failure between the access point (104) and the terminal (106) is also acquired. Further, a second indication of signal quality of a signal received by the access point (104) from the terminal (106) after such an indication of communication is acquired. The first and second indications of signal quality are compared and the transmission power of the access point (104) is regulated according to the result of the comparison.

### BACKGROUND

A Wireless Local Area Network (WLAN) often comprises a number of access points (APs) under the control of an access controller (AC). In a WLAN, individual user terminals (often designated STA, for station) exchange signals with an AP. The signals undergo a varying degree of signal attenuation, for example as terminals move closer or further away from an AP, or a source of interference such as a microwave is introduced. In addition, APs may reduce their transmission power under the control of the AC, for example under a wireless network radio resource management (WRRM) scheme, which can lead to communication failure between an AC and a terminal.

### BRIEF DESCRIPTION OF THE DRAWINGS

FIG. 1 shows an example of a schematic layout of a WLAN network;

FIG. 2 shows an example of a method;

FIG. 3 shows an example of a method carried out at a wireless access point;

FIG. 4 is an example of a TLV format;

FIG. 5 shows an example of a power regulation method carried out at a controller;

FIG. 6 shows another example of a power regulation method carried out at a controller;

FIGS. 7A and 7B shows an example of how a power increment to be made during power regulation may be determined;

FIG. 8 is a schematic structural drawing of an example of a wireless controller for performing power regulation of an access point; and

FIG. 9 is a schematic structural drawing of an example of a wireless access point which may undergo power regulation.

### DETAILED DESCRIPTION

The present disclosure is explained in detail, by way of example only, with reference to the accompanying drawings.

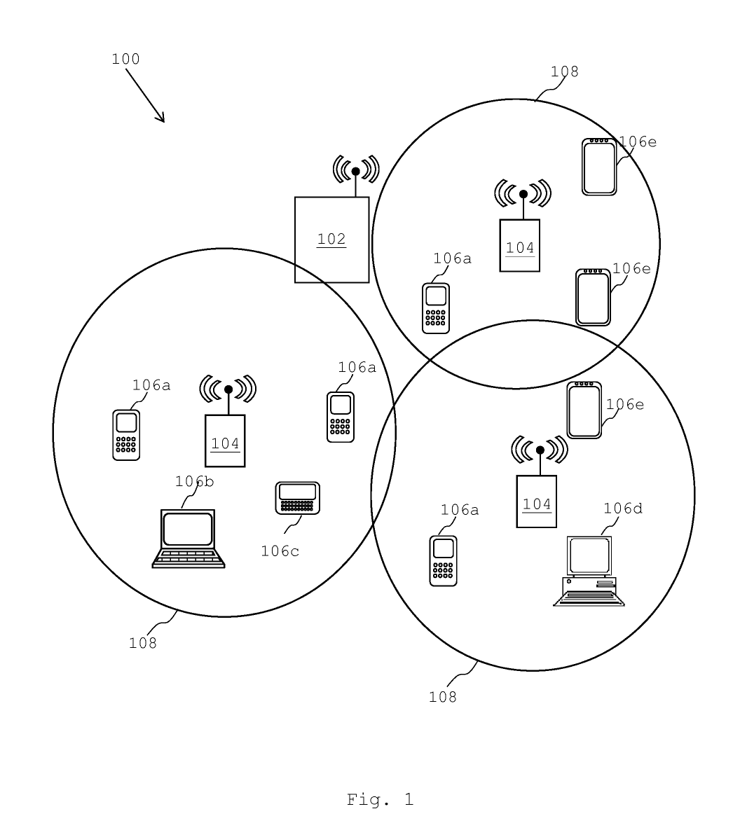

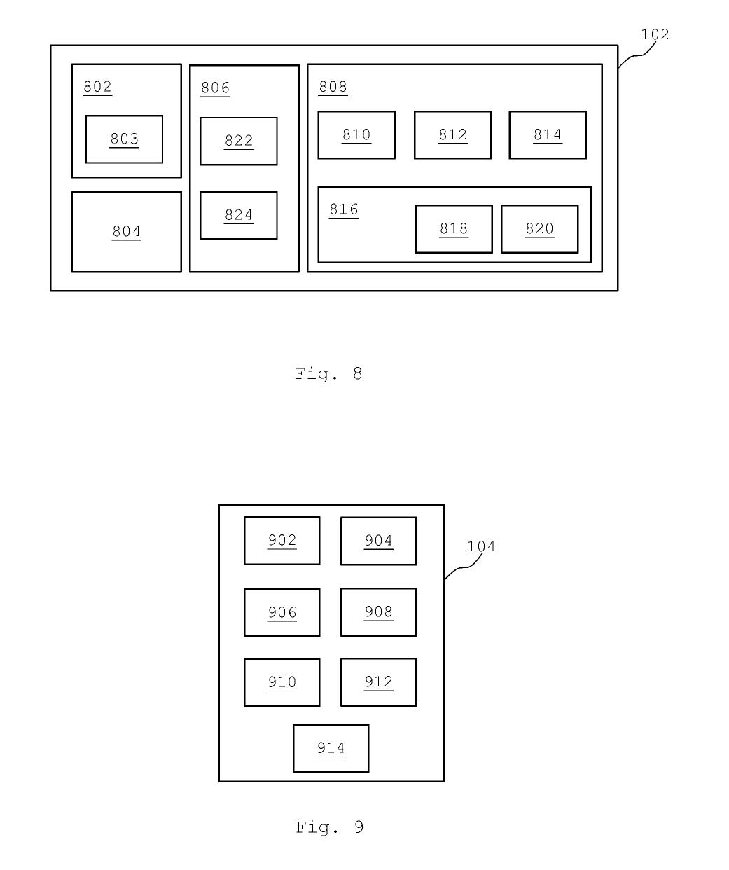

FIG. 1 shows an example of a Wireless Local Area Network (WLAN) 100. The network 100 includes a controller 102 which is in wireless communication with a number of access points 104. More detailed discussions of examples of a controller 102 and an access point 104 can be found with reference to FIGS. 8 and 9 below. Each access point 104 is in wireless communication with terminal devices 106a-e (generally referred to as terminal 106 herein), which are for example any of mobile telephones 106a, lap-top computers 106b, personal digital assistants (PDAs) 106c, desktop computers 106d and tablet devices 106e.

The controller 102 may dynamically regulate the power of the access points 104 according to a WLAN Radio Resource Management (WRRM) scheme. Such schemes are intended to ensure that the WLAN 100 responds to changes in the wireless environment. For example, there may be a limited number of channels available for operation in the network 100, and each access point 104 may be limited to having a maximum number of neighbouring access points that are detectable by that access point to limit interference between access points 104 operating on the same channel. If this number is exceeded, the power of one, some, or all the access points 104 may be reduced. In another example, power regulation may be according to the number of terminals 106 associated with a given access point 104 at that time, and/or their distance from the access point 104. Such methods may be carried out following communication between the access points 104 and the controller 102.

The transmission power of an access point 104 is related to the region over which it provides signal coverage (illustrated in the Figure as zones of coverage 108 for each access point 106. Although these are shown as circular, in a practical environment they may have any shape as determined by their local environment). When the transmission power of an access point 104 is reduced, its zone of coverage 108 becomes smaller, and a terminal 106 at the edge of a zone 108 may lose signal coverage and become unable to access wireless services.

In other words, once a wireless connection has been established between a terminal 106 and an access point 104, it can be lost if an access point 104 reduces its power, for example due to WRRM. However, there are other reasons for communication failure. For example, the terminal 106 may simply have moved out of the zone of coverage 108, or there may be a new source of interference or attenuation. For example, microwave ovens are known to interfere with WLAN signals when operated, or an object such as a vehicle may move between a terminal 106 and an access point 104, resulting in increased attenuation of the wireless signal. In order to remedy a communication breakdown appropriately, it would be helpful to be able to infer a cause of the loss of signal.

According to the specification of communication protocols such as the IEEE 801.11 series of protocols, when communication between a terminal 106 and an access point 104 is interrupted, the terminal 106 attempts to reconnect to the access point 104. This attempt starts by the terminal 106 sending a probe frame, or probe request, to the access point 104. When the access point 104 receives the probe frame, it responds with a probe response frame. If the terminal 106 is in the zone of signal coverage, the terminal 106 receives the probe response frame and sends back a probe response acknowledgement (ACK) message to the access point 104.

However, if the transmission power of the access point 104 is insufficient to provide a zone of coverage 108 which reaches the terminal 106, the probe response frame sent by the access point 104 will have been attenuated before reaching the terminal 106. This means the terminal 106 does not receive any messages (including the probe response frame) from the access point 104, so the terminal 106 does not send an acknowledgement.

In an example of the present disclosure, if communication fails between the access point 104 and the terminal 106, a corresponding indication of the communication failure may be acquired, and said indication of communication failure may trigger power regulation of the access point 104.

In some examples, an indication of communication failure is an indication that a transmission power is too low. The indication of communication failure may for example be the access point 104 not receiving an acknowledgement message from the terminal 106. That may indicate that the power of the access point 104 is too low to provide a zone of coverage 108 which extends to terminal 106. In one example, it is taken as an indication of communication failure if (i) a signal from the terminal has been received at the access point 104, (ii) a signal has been sent from the access point 104 to the terminal 106, and (iii) an acknowledgement of the signal sent from the access point 104 to the terminal 106 has not been received at the access point 104 from the terminal 106.

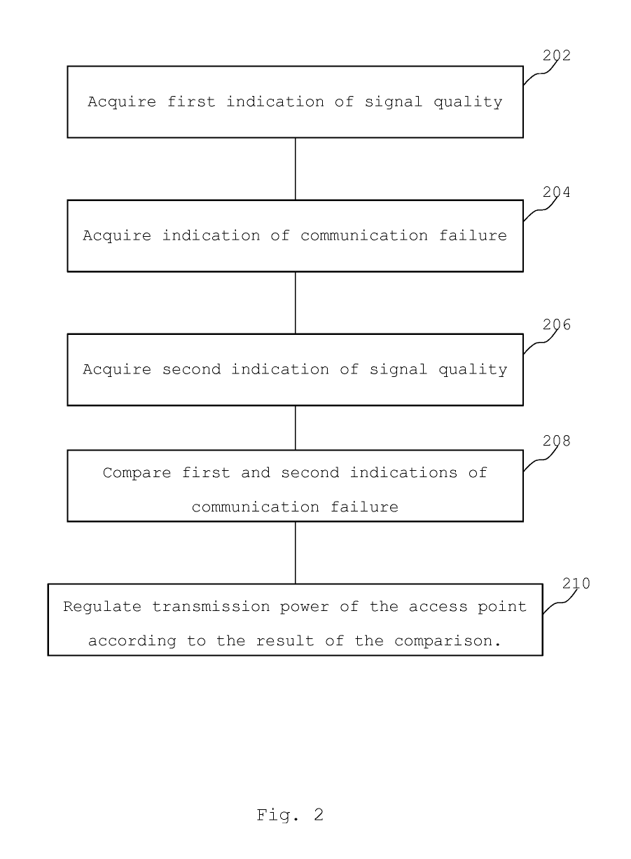

In an example of a method of power regulation, the quality of signals sent from a terminal 106 are considered. The terminal signal quality before and after an indication of communication failure may be compared, the transmission power of the access point 104 controlled according to the result of the comparison. Such an example method may, as is shown in FIG. 2, comprise acquiring a first indication of signal quality of a signal received by an access point 104 from a terminal 106 (block 202). The method may then continue as in block 204, by acquiring an indication of a communication failure between the access point 104 and the terminal 106. Next, following the indication of the communication failure, in block 206, a second indication of signal quality of a signal received by the access point 104 from a terminal 106 is acquired. In block 208, the method continues by comparing the first indication of signal quality and the second indication of signal quality and, in block 210, regulating the transmission power of the access point 104 according to the result of the comparing.

Analysing the results of the comparison allows a reason as to why the terminal 106 has lost signal coverage to be inferred. This in turn allows an appropriate power regulation scheme to be carried out, which is likely to better address the circumstances resulting in the communication failure. Such a scheme may include enlarging the signal coverage of the wireless network, thereby reducing interference in the wireless environment and increasing throughput of the entire system.

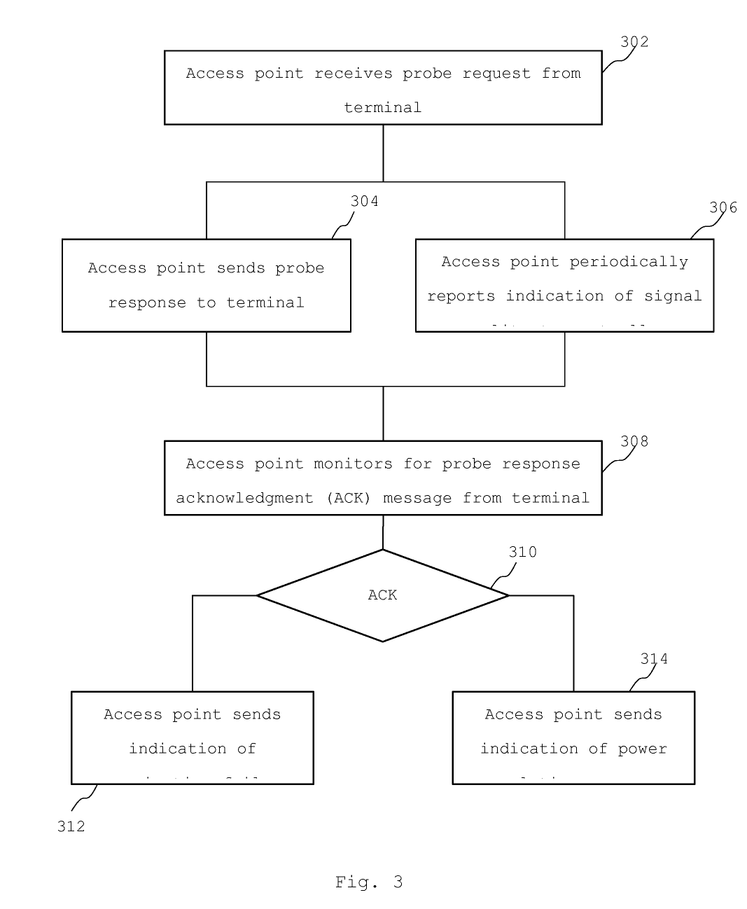

FIG. 3 shows a flow chart concerning a wireless access point 104.

In block 302, the access point 104 receives a probe request from the terminal 106. This probe request may, for example, be a probe request frame as defined in the 802.11 IEEE standards.

In block 304, the access point 104 sends a probe response to the terminal 106.

In addition, the access point 104 determines an indication of signal quality and, in block 306, the access point 104 reports this indication of signal quality to the controller 102.

Such an indication of signal quality can be obtained from one or several wireless frame messages sent from the terminal 106. For example, the terminal 106 may include signal quality data in wireless frame messages, for example including the terminal's own signal level and signal-to-noise ratio (dBm) in the message information (Packet Info) of the frame message. In other examples, the Received Signal Strength may be used.

As long as the transmission power of the terminal 106 is higher than that of the access point 104 and provides a zone of coverage which includes the access point 104, the message from the terminal 106 can be transmitted to the access point 104 whether the terminal 106 is within the signal coverage zone 108 of the access point 104 or outside it.

In addition, the intervals between frame messages sent by the terminal 106 can be set as appropriate. This may be, for example, 100 milliseconds. The interval between the access point reports of the signal quality data of the terminal 106 to the controller 102 (the ‘reporting period’) may be set accordingly to be either equal or not equal to interval between frame messages. In some examples, the detection of terminal signal quality and/or the reporting period may be shorter once a communication failure has been identified. This provides additional data to allow appropriate power regulation to be carried out.

In one example, reporting the indications of signal quality to the controller 102 by the access point 104 comprises the access point 104 periodically reporting a first message comprising a TLV (type-length-value) format to the controller 102, wherein the first message comprises terminal signal quality data.

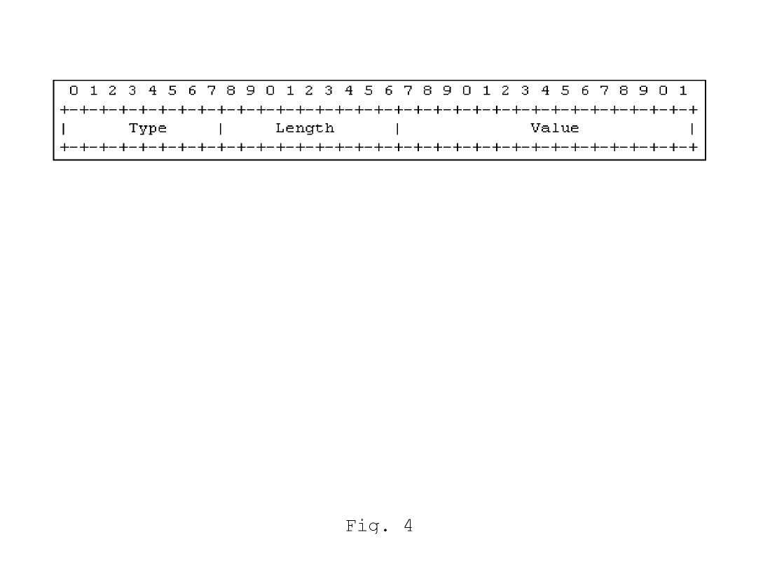

FIG. 4 is an example of a TLV format, wherein field T represents the message type, field L represents the message length, and field V is usually used for storing the content of the message.

In one example, the first message may be a LWAPP (Lightweight Access Point Protocol) message or a CAPWAP (Control And Provisioning of Wireless Access Point Protocol) message, although other message types could be used.

In examples, indications of signal strength may be sent periodically, and may be based on any data frames, including probe request frames, received from the terminal 106.

In block 308, the access point 104 monitors for a probe response acknowledgement message from the terminal 106.

The probe request of block 302 may have been sent by the terminal 106 when communication between the terminal 106 and the access point 104 is interrupted as the terminal 106 attempts to reconnect to the access point 104. Supposing that the communication interruption between the terminal 106 and the access point 104 is caused by a reduction in the signal coverage, and that the transmission power of the terminal 106 is higher than that of the access point 104, then a probe request frame sent by the terminal 106 may be transmitted to the access point 104, and, according to specifications of a communication protocol such as the IEEE 802.11 series of protocols, the access point 104 will respond a probe response frame. If the terminal 106 is within the signal coverage, the terminal 106 will receive the response frame and respond by sending a probe response acknowledgement message to the access point 104.

In one example, if an acknowledgement is not received within a predetermined time period, the access point 104 may retransmit the probe response frame to the terminal 106, in some examples, several times up to a predetermined number of attempts.

However, should it be determined in block 310 that no acknowledgement has been received to any such response frame(s), in block 312, this is reported by the access point 104 to the controller 102 as an indication of communication failure.

In such a case, it can be inferred that the probe response frame sent by the access point 104 has been attenuated before reaching the terminal 106, which has therefore not received the probe response frame, and accordingly does not send a probe response acknowledgement message to the access point 104. However, as the signal from the terminal 106 is still reaching the access point 104, it can be inferred that the terminal 106 is still in an active state, and has lost signal coverage because the power of the access point 104 is too low for the signal to reach the access point 104. Therefore, the indication of communication failure in this example is an indication that the transmission power is too low.

In an example of the present disclosure, the access point 104 reporting the indication of communication failure to the controller 102 may comprise the access point 104 reporting a second message of a TLV format to the controller 102, wherein the value part (V) of said second message is zero.

The second message and the first message may have similar formats and/or structures. For example, the second message in the example of the present disclosure can be a LWAPP message or a CAPWAP message (although other message types could be used). In the example of TVL messages, the Value part in the TLV format of the first message may be a value giving an indication of signal quality data of the corresponding terminal 106, while the Value part in the TLV format of the second message may be zero.

In an example, if the method is being carried out following a power regulation of the access point 104 by the controller 102, upon receiving the probe response acknowledgement message from the terminal 106, the access point 104 may, in block 314 send an indication to the controller 102 to report that the power regulation has been successful (in that communication with that terminal 106 has been maintained or restored).

To consider one example of power regulation in more detail, following receipt of the indication of communication failure, the controller 102 may regulate the access point power according to the result of comparison of the terminal signal quality before and after the indication of communication failure, as further detailed herein below. Whether the access point power regulation has achieved the desired effect can be determined through whether the probe response acknowledgement message sent by the terminal 106 is received at the access point 104. If the probe response acknowledgement message is received, it means that the access point power regulation has restored signal coverage sufficiently to include the terminal 106 in the signal coverage zone 108 and the access point power regulation has achieved the desired effect.

FIG. 5 is a flow chart of a power regulating method for a wireless access point 104 in an example of the present disclosure.

In block 502 (and perhaps periodically), the controller 102 receives a first indication of terminal signal quality from an access point 104.

In block 504, the controller 102 receives an indication of communication failure of the type explained above, as reported by the access point 104.

Next, in block 506, the controller 102 receives a second indication of terminal signal quality from an access point 104. Again, in practise, this may be received periodically, such that several messages concerning signal quality are received after the indication of communication failure and may be used to provide an indication of signal quality.

In block 508, the controller 102 compares the first and second indications of signal quality, i.e. those from before and after the indication of communication failure.

In block 510, the controller 102 performs access point power regulation according to the result of the comparison.

Reasons for a loss in signal coverage can be inferred by analyzing the result of comparison, allowing an appropriate power regulation scheme to be employed.

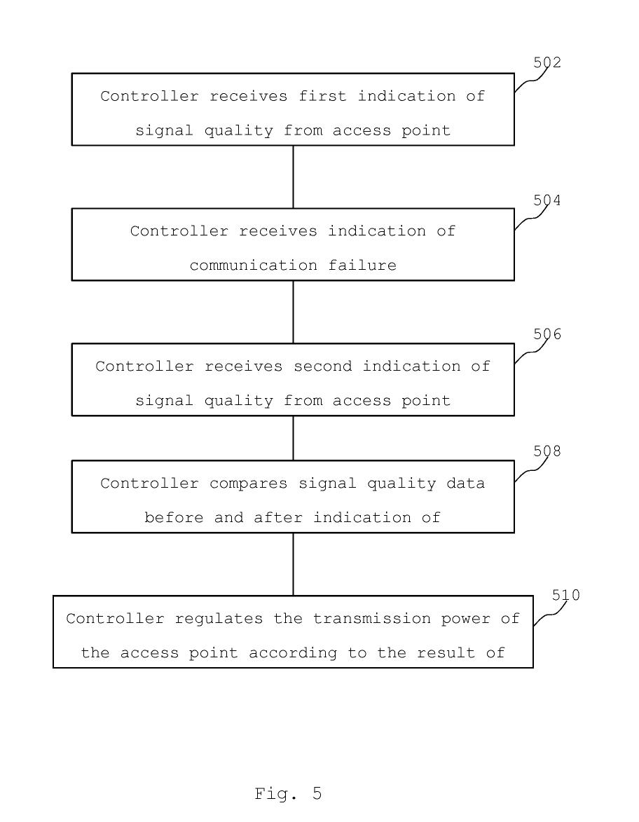

In one particular example, as set out in FIG. 6, the controller 102 receives periodic indications of the terminal signal quality (block 602), which it holds in a memory. Then, in block 604, the controller 102 sends a message to reduce the transmission power of the access point 104. This reduction may be part of a WRRM scheme. For example, the access point transmission power may be dynamically regulated according to the number of the access points 104 in the network 100. The addition of new access point 104 to a WLAN 100 may result in a reduction of access point transmission power. To consider one example, the transmission power of the access point 104 before and after reduction may be 10 dBm and 8 dBm respectively.

If, in block 606, an indication of communication failure is received, the controller 102 continues to receive periodic indications of the terminal's signal quality (for example from its probe request data frames) (block 608). In order to compare the signal strength before and after the communication failure, the controller 102 prepares reference data from indication(s) of signal quality obtained before the communication failure (block 610). This reference data may be created from signal(s) received over a period of time (for example, and without limitation, 1 or 2 minutes) before the communication failure. The reference data could be derived using a mathematical, for example, statistical method such as averaging, weighted averaging, moving averaging, moving weighted averaging, etc., although other methods could also be used.

Likewise, in order to make the comparison, mathematical, for example statistical, methods may also be applied to process indication(s) of signal quality received after the communication failure to provide processed data (block 612). This processed data is compared with the reference data (block 614).

In such an example, performing access point power regulation by the controller 102 according to the result of the comparison includes analyzing changes of the terminal signal quality before and after the indication of communication failure to determine if there has been a decrease in signal quality (block 616). If the result of analysis is that the terminal 106 signal quality does not change before and after said indication of communication failure (or at least has not deteriorated), then it may be inferred that the WRRM power reduction carried out in block 604 resulted in the loss of coverage, and the power regulation restores the transmission power of the access point 104 to that which it was before the reduction (block 618).

If however the signal after said indication of communication failure is smaller or weaker than the terminal signal beforehand, it can be inferred that terminal movement, interferences from other signals or otherwise increased attenuation along the signal path have at least contributed to, if not caused, the terminal 106 to lose the signal coverage. In such an example, the controller 102 can increase the access point power appropriately, specifically in this example by increasing power of the access point 104 by a predetermined increment (block 620).

The change in the signal strength may be required to meet certain thresholds in order for a change in signal quality to be identified as such. For example the change in signal quality may be required to be at least an amount representing a proportion of the signal strength, or a predetermined absolute change in signal strength, in order for a change in signal quality to be determined. This prevents relatively minor variations, for example due to signal collection or processing techniques, from leading to a determination that the terminal signal has changed (or in particular deteriorated).

In one example, the controller 102 sends a power regulation instruction to cause the access point 104 to increase its transmission power, and the access point 104 increases the power according to the regulation instruction.

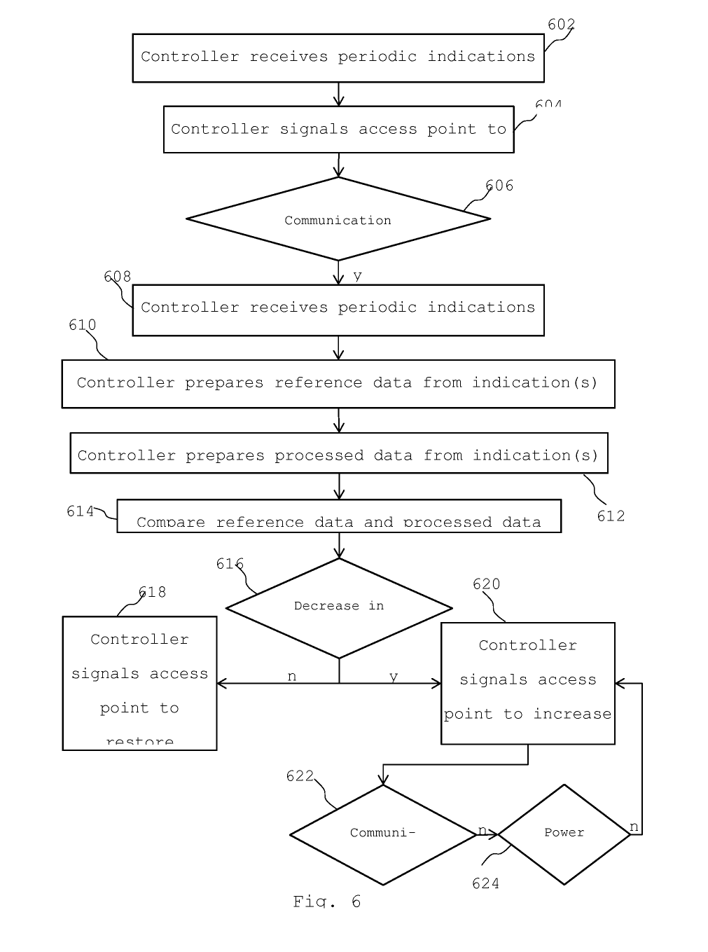

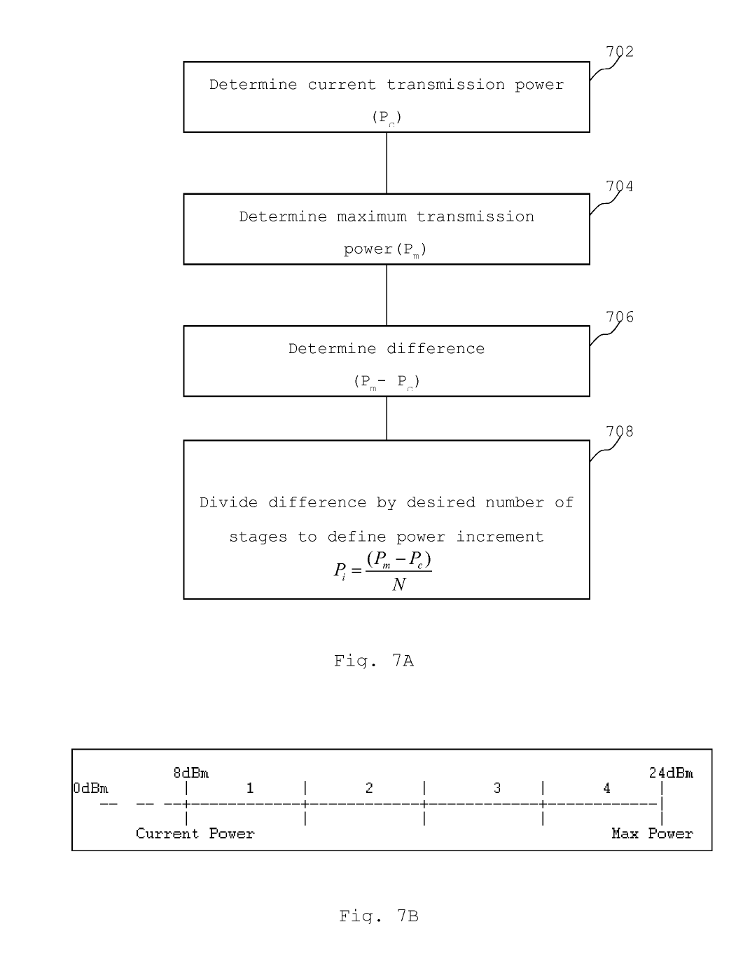

In one example, such regulation may be made in a series of regular increments. The increment may be defined as described in relation to the examples of FIG. 7A and FIG. 7B by considering the current power of the access point 104, the maximum power of the access point 104 and the number of the stages of increase desired.

To that end, in block 702, the controller 102 determines the current transmission power of the access point 104. Further, in block 704, the controller 102 determines the maximum transmission power of the access point 104. In block 706, the controller 102 determines the difference between Pₘ and P_{c}, before dividing this by the number of stages for power regulation N, which may be set according to the circumstances (block 708). In particular, the value of N may be chosen to balance the need to restore coverage to a terminal 106 rapidly with a desire to limit interference in the network 100. This gives a power increase increment Pᵢ:

$${P}_{i} = \frac{( {P}_{m} - {P}_{c} )}{N}$$

A specific example is now discussed with regard to FIG. 7B. In this example, the current power of the access point 104 is 8 dBm, the maximum power of the access point 104 is 24 dBm, and the number of stages of increase is set as 4, then the power increase increment is:

$${P}_{i} = \frac{( 24 - 8 )}{4} = 4 dBm$$

In this case, in each of the first to fourth stages of increase, the current power of the access point 104 can be increased by 4 dBm, so the regulated access point power corresponding to the first to fourth stages of increase is 12 dBm, 16 dBm, 20 dBm and 24 dBm.

As has been mentioned in relation to block 314, when the terminal 106 that had lost signal cover is back inside a signal coverage zone 108, the access point 104 can report information of an event of power regulation success to the controller 102. This indication of success can be used to interrupt the process of increasing the transmission power by increments (block 622). In other words, the controller 102 receiving the indication of a communication failure may trigger the start of the access point power regulation, and the controller 102 receiving the indication of power regulation success may trigger the end of access point power regulation.

However, should the access point power reach the maximum power, this may also serve as a trigger to end the access point power regulation (block 624).

Other methods to increase the access point power could be used, for example, increasing the access point power randomly, increasing the access point power by a predetermined value (which may be relatively large) (e.g. 10 dBm, etc.) and the like. However, increasing the access point power randomly does not allow other factors in the network 100 to be considered and may result in undesirable and/or uncontrollable power fluctuations, and increasing the access point power by a relatively large value may produce unnecessary interferences within the WLAN 100. Therefore, these methods may not be as efficient as the method described above. Increasing the power in increments provides a balance between increasing access point power efficiently while limiting interference within the network 100.

As these methods ensure that the terminals 106 receive a good service in the WLAN 100, the examples of power regulation described above can form part of a WRRM scheme.

Referring to FIG. 8, which is a schematic representation of a controller 102 in an example of the present disclosure, a controller 102 may comprise:

a first receiver 802 to receive indications of terminal signal quality data as reported by the access point 104, and including, in this example, a memory 803 to store these indications;

a second receiver 804 to receive indications of a communication success or failure from the access point 104;

a comparing module 806 to compare terminal signal quality before and after the indication of communication failure; and

a power regulator 808 to regulate the power of the access point 104 according to the result of comparison.

In an example, the power regulator 808 may comprise:

a first power regulating module 810 to regulate the transmission power of an access point 104 by increasing or reducing the power of the access point according to wireless network managing protocols;

an analyzing module 812 to determine, according to the result of a comparison, whether there has been a change between the first indication of signal quality and the second indication of signal quality, wherein the first indication of signal quality is an indication of the quality of a signal received before a power reduction by the first power regulating module, and the second indication of signal quality is an indication of the quality of a signal received after the power reduction by the first power regulating module;

a second power regulating module 814 to restore the transmission power of an access point 104 to the transmission power prior to a reduction by the first power regulating module 810 in the event that the analyzing module 812 determines that there has been no change (or at least no reduction) between the first indication of signal quality and the second indication of signal quality; and

a third power regulating module 816 to increase the transmission power of an access point 104 in the event that the analyzing module 812 determines that there has been a reduction in signal quality between the first indication of signal quality and the second indication of signal quality.

The power regulating modules 812, 814, 816 may transmit a power regulation signal to an access point 104.

In this example, the third power regulating module 816 may comprise:

a power increase increment unit 818 to determine a magnitude for a power increase increment, the magnitude comprising the difference between the current power of the access point 104 and the maximum power of the access point 104 divided by a predetermined integer equal to the number of desired stages between the current power and the maximum power;

a power regulating sub-module 820 to increase the transmission power of the access point 104 by an amount equal to the power increase increment. This may continue until receiving an indication of an event of power regulation success (i.e. communication between the access point 104 and the terminal 106 is restored) reported by the access point 104 or until the transmission power of the access point 104 reaches its maximum.

The comparing module 806 may further comprise:

a reference acquiring sub-module 822 to acquire reference data from indication(s) of terminal signal quality received before the indication of communication failure; and

a reference comparing sub-module 824 to compare the indication(s) of signal quality received after the indication of communication failure with the signal quality reference data of the terminal 106 to obtain a corresponding result of the comparison.

FIG. 9 is a schematic representation of a wireless access point 104 in an example of the present disclosure, which comprises:

a first reporting module 902 to report the signal quality data of the terminal 106 to the controller 102;

a sending module 904 to send a probe response message to a terminal 106;

a monitoring module 906 to monitor for a probe response acknowledgement message from a terminal 106;

a second reporting module 908 to report, to the controller 102, an indication of communication failure in the event that no probe response acknowledgment is received; and

a transmission power control module 910, arranged to control the signal transmission power under the control of the controller 102.

In an example of the present disclosure, said first reporting module 902 may be used to periodically report a first message of a TLV (type-length-value) format to the controller 102, wherein said first message comprises terminal signal quality data.

In another example of the present disclosure, said second reporting module 908 may be used to report a second message of a TLV format to the controller 102, wherein the value part of said second message is zero.

In this example, the access point 104 further comprises:

a third reporting module 912 to report an indication of communication success to the controller 102, in the event that a probe response acknowledgment is received, and

a signal quality assessment module 914, to determine an indication of signal quality from a signal received from a terminal 106.

The examples of the present disclosure can be provided as method, system or machine readable instructions, such as any combination of software, hardware, firmware or the like. Such machine readable instructions may be included on a computer readable storage medium (including but is not limited to disc storage, CD-ROM, optical storage, etc.) having computer readable program codes therein.

The present disclosure is described with reference to flow charts and/or block diagrams of the method, device (system) according to examples of the present disclosure. It shall be understood that each flow and/or block in the flow charts and/or block diagrams as well as combinations of the flows and/or diagrams in the flow charts and/or block diagrams can be realized by machine readable instructions. The machine readable instructions may be provided to a general purpose computer, a special purpose computer, an embedded processor or processors of other programmable data processing devices to generate a machine, so that an apparatus is produced for realizing functions specified by one or more flows in the flow charts and/or one or more blocks in the block diagrams through instructions executed by the computer or processors of other programmable data processing devices. The term ‘processor’ is to be interpreted broadly to include a CPU, processing unit, ASIC, logic unit, or programmable gate array etc.). The methods and functional modules may all be performed by a single processor or divided amongst several processers.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operation steps to produce computer-implemented processing, thus the instructions executed on the computer or other programmable devices provide a step for realizing functions specified by one or more flows in the flow charts and/or one or more blocks in the block diagrams.

Further, the teachings herein may be implemented in the form of a software product, the computer software product being stored in a storage medium and comprising a plurality of instructions for making a computer device (e.g. a personal computer, a server or a network device such as a router, switch, access point 104 etc.) implement the method recited in the examples of the present disclosure.

Although the flow diagram described above show a specific order of execution, the order of execution may differ from that which is depicted. Functions ascribed to the controller 102 may be carried out by an access point 102 and vice versa.

It should be understood that examples of the method and devices described above are implementation examples only, and do not limit the scope of the disclosure. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A method of transmission power regulation of a wireless access point comprising:
acquiring a first indication of signal quality of a signal received by the access point from a terminal;
acquiring an indication of a communication failure between the access point and the terminal;
acquiring a second indication of signal quality of a signal received by the access point from a terminal following the indication of the communication failure;
comparing the first indication of signal quality and the second indication of signal quality; and
regulating the transmission power of the access point according to the result of said comparing.

2. The method of claim 1
further comprising reducing the transmission power of the access point, wherein the first indication of signal quality is an indication of the quality of a signal received before the transmission power reduction and the second indication of signal quality is an indication of the quality of a signal received after the transmission power reduction.

3. The method of claim 2, wherein comparing the first indication of signal quality and the second indication of signal quality comprises determining if there has been a change in the signal quality,
and regulating the transmission power of the access point according to the result of the comparing comprises:
if there is no change between the first indication of signal quality and the second indication of signal quality, restoring the transmission power of the access point prior to the reduction;
if there is a decrease in signal quality between the first indication of signal quality and the second indication of signal quality, increasing the transmission power of the access point.

4. The method of claim 3, in which increasing the transmission power of the access point if there is a decrease in signal quality between the first indication of signal quality and the second indication of signal quality comprises:
determining a magnitude for a power increase increment, the magnitude comprising the difference between the current transmission power of the access point and the maximum transmission power of the access point divided by a predetermined integer equal to the number of desired stages between the current transmission power and the maximum transmission power,
increasing the transmission power of the access point by an amount equal to the power increase increment,
monitoring for an indication of communication success between the access point and the terminal, and, if an indication of success is not received, increasing the transmission power of the access point by the power increase increment until an indication of communication success is received or until the transmission power of the access point is equal to the maximum transmission power.

5. The method of claim 1, in which
(i) the signal from the terminal received at the access point is a probe request signal from the terminal,
(ii) the signal sent from the access point to the terminal is a probe response signal,
the method comprising monitoring, by the access point, for a probe response acknowledgment from the terminal,
wherein the indication of communication failure indicates that no probe response acknowledgment is received.

6. The method of claim 1, which comprises acquiring an indication of communication success, the method further comprising:
receiving, by the access point, a probe request from the terminal,
sending, from the access point, a probe response
monitoring, by the access point, for a probe response acknowledgment from the terminal,
wherein the indication of communication success indicates that a probe response acknowledgment is received by the access point.

7. The method of claim 1 in which
acquiring the first and second indications of signal quality of a signal received by the access point from a terminal comprises receiving an indication of signal quality sent from the access point to an access controller;
acquiring an indication of a communication failure between the access point and the terminal comprises receiving an indication of a communication failure sent from the access point to the access controller, in which the indication of communication failure is an indication that the transmission power of the access point is too low;
comparing the first indication of signal quality and the second indication of signal quality comprises comparing the indications of signal quality by the access controller; and
regulating the transmission power of the access point comprises the access controller controlling the transmission power of the access point.

8. The method of claim 1 in which indications of signal quality are sent periodically and the intervals between sending indications of signal quality before an indication of communication failure are greater than the intervals between sending indications of signal quality after an indication of communication failure.

9. A controller to control a wireless network, comprising:
a first receiver to receive indications of signal quality of a signal received by an access point from a terminal;
a second receiver to receive an indication of communication failure from the access point;
a comparing module to compare a first indication of signal quality of signals received before the indication of communication failure and a second indication of signal quality of signals received after the indication of communication failure; and
a power regulator to regulate the transmission power of the access point according to the result of said comparing.

10. The controller of claim 9, in which the power regulator comprises a first power regulating module to regulate the transmission power of an access point by increasing or reducing the transmission power of the access point according to network management protocols.

11. The controller of claim 10 in which the power regulator further comprises:
an analyzing module to determine, according to the result of the comparing carried out by the comparing module, whether there has been a change between the first indication of signal quality and the second indication of signal quality, wherein the first indication of signal quality is an indication of the quality of a signal received before a power reduction by the first power regulating module, and the second indication of signal quality is an indication of the quality of a signal received after the transmission power reduction by the first power regulating module;
a second transmission power regulating module to restore the transmission power of an access point to the transmission power prior to reduction by the first power regulating module in the event that the analyzing module determines that there has been no significant change between the first indication of signal quality and the second indication of signal quality;
a third power regulating module to increase the transmission power of an access point in the event that the analyzing module determines that there has been a decrease in signal quality between the first indication of signal quality and the second indication of signal quality.

12. The controller of claim 11, in which the third power regulating module comprises:
a power increase increment unit to determine a magnitude for a power increase increment, the magnitude comprising the difference between the current transmission power of the access point and the maximum transmission power of the access divided by a predetermined integer equal to the number of desired stages between the current transmission power and the maximum transmission power;
a power regulating sub-module to increase the transmission power of the access point by an amount equal to the power increase increment.

13. A wireless access point, comprising:
a first reporting module to report, to a controller, a first and a second indication of signal quality of a signal received at the access point from a terminal;
a sending module to send a probe response message to a terminal;
a monitoring module to monitor for a probe response acknowledgement message from a terminal;
a second reporting module to report to the controller an indication of communication failure in the event that no probe response acknowledgment is received;
and
a transmission power control module, arranged to control the signal transmission power of signals sent from the wireless access point under the control of the controller,
wherein the first indication of signal quality is determined for signals received before the indication of communication failure and second indication of signal quality is determined for signals received after the indication of communication failure.

14. The wireless access point of claim 13, further comprising a signal quality assessment module, arranged to determine an indication of signal quality from a signal received from a terminal.

15. The wireless access point of claim 13, characterized by further comprising:
a third reporting module to report to the controller an indication of communication success in the event that a probe response acknowledgment is received.
